(19) United States
(12) Patent Application Publication
(10) Pub. No.: US 2009/0231137 A1
(43) Pub. Date: Sep. 17, 2009

(54) BIOLOGICAL SENSING METER AND DATA COMMUNICATING METHOD THEREOF

(75) Inventors: Ya-Hsin Chuang, Taipei County (TW); Meng-Yi Lin, Taipei County (TW)

Correspondence Address: SCHMEISER OLSEN & WATTS, 18 E UNIVERSITY DRIVE, SUITE # 101, MESA, AZ, 85201, US

(73) Assignee: HEALTH & LIFE CO.,LTD, Taipei County (TW)

(21) Appl. No.: 12/404,582

(22) Filed: Mar. 16, 2009

(30) Foreign Application Priority Data
Mar. 17, 2008 (TW) 097109353

(51) Int. Cl. G08B 21/00; H04Q 5/22

(52) U.S. Cl. 340/572.1; 340/10.1

(57) ABSTRACT

This present invention is a biological sensing meter and data communicating method thereof, applying an informative tag of the radio frequency identification technique to express the test item, the shelf expired date, the opening expired date, the sensing predetermined value, the number of test times as well as the test chip examination parameter and other calibration data under different test configurations. With the informative tag of the radio frequency identification technique, the test configuration can be set for testing different items, controlling the expired date of the test chip, and restoring test results of different test items.

### TECHNICAL FIELD

The present invention relates to a biological sensing meter and data communicating method, and more particularly, to a biological sensing meter and data communicating method. The biological sensing meter is implemented by RFID (Radio Frequency Identification) technique for managing the shelf expired date and the amount of strips. The data communicating method is capable of regulating parameters from the biological sensing meter automatically.

### BACKGROUND ART

A biological sensing meter is one kind of combinative transducer for immobilized biomolecules, which is utilized for sensing environmental chemical matters inside or outside of vivo. The biological sensing meter is also a device conducting specific interactions with the environmental chemical matters. In consideration of techniques of IVDD (In Vitro Diagnostic Device) at present, the biological sensing meter for outside vivo sensing should be operated with a biological sensing strip when it activates its metering functions. Due to the reasons of manufacturing process techniques in the field of biological sensing strips, there are characteristic differences among different lots of biological sensing strips lot-by-lot. For reducing the differences reflecting in metering results from the characteristic differences among different lots, each package of the biological sensing strips is given a group of calibration code to conduct corresponding calculation or compensation according to characteristic of the strip so as to obtain consistent results precisely.

Conventional data configuration processes could be distinguished into two types. One is to select a corresponding calibration code built in a memory of the biological sensing meter according to a calibration code registered on the package of a lot of strips by a user. Attaching a code card containing calibration codes with each lot when each lot leaves the manufactory by a manufacturer is the other one. A memory unit, such as an EEPROM, stores the calibration codes. When a user inserts the code card into the biological sensing meter before metering, the biological sensing meter receives the calibration codes in the memory unit of the code card so as to get the calibration codes corresponding to this lot of strip. Since each of the two types must conduct an operation for giving calibration codes to the biological sensing meter by the user, the biological sensing meter may receives incorrect calibration codes from the negligence or operating mistakes of the user so as to cause incorrect metering results. Moreover, the operating for giving calibration codes may increases operating time as well as causes inconveniences for the user. Therefore, it is quite unpractical.

In addition, since the strips used for metering have its specific expired dates, the user must manage the strips carefully to avoid incorrect metering results because of using expired strips. In general, expired date include a shelf expired date and an opening expired date, wherein the shelf expired date is indicated in a package, an instruction or a specification in common, such as a manufacturing date and a shelf expired date, and the opening expired date means a date after the user seals off the package. Although environment factors (such as temperature or humidity) may influence quality of sealed off strips and further influence accuracy of test, the user still ignores controls of strips quality because of temporarily conveniences or negligence usually so as to influence results of the test.

As described above, it is to an improved solution that is capable of adjusting parameters automatically without users so as to cause the biological sensing meter to not only have precise metering functions but also manage expired dates of strips effectively. Moreover, it is also an improved solution that the user may test different test items and the number of tests in different test items and further record test results of different test items.

### SUMMARY OF THE INVENTION

In accordance with one aspect of the invention, a biological sensing meter and data communicating method are provided for configuring and testing configuration by tag information implemented by RFID technique. More particularly, in the operation of sending the tag information into the sensing meter, the sensing meter may manages a expired date and an opening expired date respectively in accordance with information content and the time of the sending operation, wherein the opening expired date is obtained by referring to the time of the sending operation and the predetermined opening expired date. When the expired date or the opening expired date is expired, the biological sensing meter informs a user about this situation or just further limits the sensing function to warn the user about needs for replacing new strips so as to achieve the function about managing the expired date the strips.

In accordance with another aspect of the invention, a communicating method capable of replacing conventional data adjusting method is provided. The communicating method is capable of storing information in a wireless data storage unit of the present invention. The wireless data storage unit could be designed to configure with package can or package storing the strips.

In one embodiment of the invention, a biological sensing meter at least comprises: a wireless transmitting/receiving unit for receiving a tag information or further sending specific information back to a wireless storage unit, a control unit, a strip tank, a sensing unit and a memory unit. The control unit is capable of conducting all signal processes in the biological sensing meter and controlling operations of all of the units inside the biological sensing meter. Furthermore, the control unit configures test configuration according to the tag information and calculates test results from responding signals. When the test configuration is in an abnormal state, the control unit informs a user about this situation or just further exterminates the sensing function. The strip tank is for inserting the strip. The sensing unit limits sensing functions in accordance with the test configuration provided by the control unit so as to sense the strip to generate a response signal and send the response signal back to the control unit. The memory unit is capable of storing all information and record inside the biological sensing meter.

The present invention discloses a data communicating method for the biological sensing meter at least comprising below steps:

At first, pre-storing a tag information in a wireless storage unit, then receiving the tag information through a wireless transmit/receive unit, then configuring a test configuration of the tag information through a control unit and inserting a strip into a strip tank, then determining if a sensing function is capable of operating continuously or not according to the test configuration, in the end, collating response signals on the strip and output test results.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1A is the biological sensing meter in accordance with a first embodiment of the present invention.

FIG. 1B is the biological sensing meter in accordance with a second embodiment of the present invention.

FIGS. 2 A and 2B are the flow charts of the communicating method of the biological sensing meter of the present invention.

FIG. 3 is the operating flow chart of operating strips test implemented via the biological sensing meter of the present invention.

### DESCRIPTION OF THE EMBODIMENT

Reference will now be made in detail to the embodiments of the present invention. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, and components have not been described in detail as not to unnecessarily obscure aspects of the present invention.

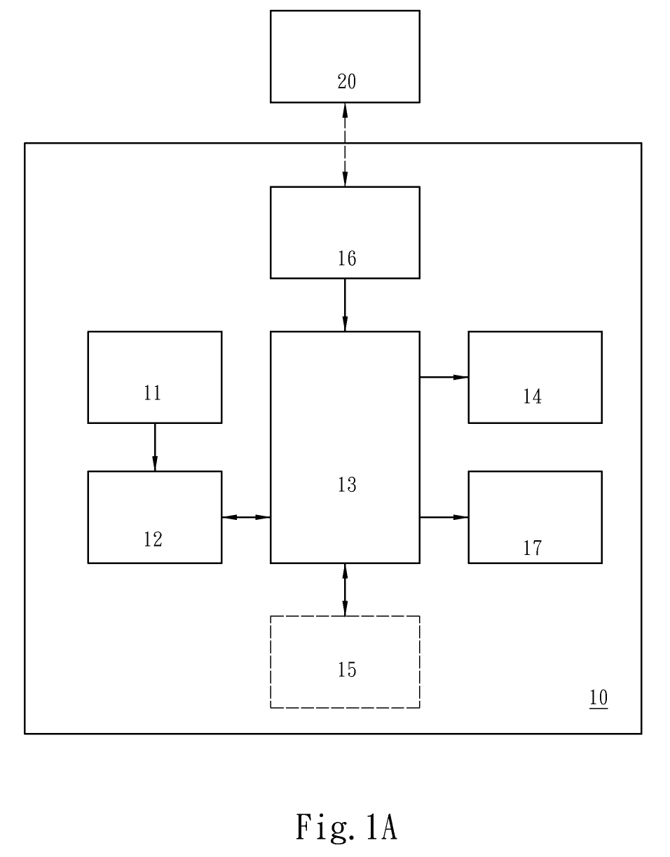

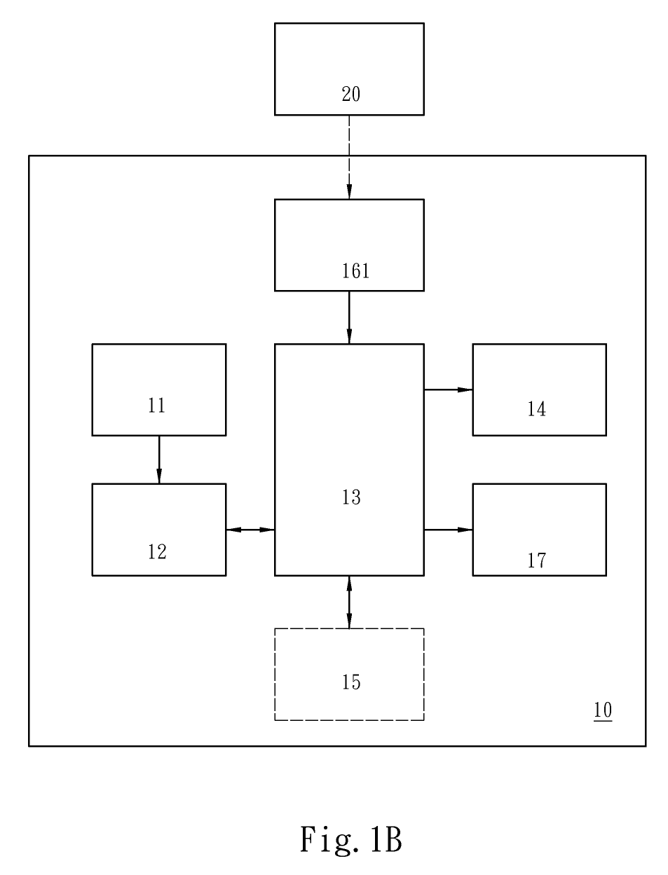

The present invention relates to a biological sensing meter and data communicating method. Before the method according to one embodiment of present invention is provided, the structure according to one embodiment of present invention is disclosed firstly. Please referring to FIG. 1A, FIG. 1A illustrates a block diagram of a biological sensing meter according to a first embodiment of the present invention. As illustrated in FIG. 1A, a biological meter 10 of the present invention mainly comprises at least one strip tank 11, a sensing unit 12, a control unit 13, an output unit 14, a counting unit 15, a wireless transmitting/receiving unit 16 and a memory unit 17. A strip is inserted into the strip tank 11 for sensing process. If the biological sensing meter 10 is capable of sensing a plurality of physiological parameter, such as concentrations of blood sugar and urine protein, the biological sensing meter 10 could utilize the strip tank 11 to place various specific test strips. If sizes and specs among the test strips are quite different, a plurality of strips tank could be configured in the biological sensing meter 10 to fit acquirement for inserting the test strips with different sizes and specs. The sensing unit 12 limits sensing functions according to a test configuration provided by the control unit so as to collate the strips for generating a response signal and send the response signal back to the control unit 13. The test configuration at least comprises a test item (different biological parameter between creatures), an expired date, a sensing predetermined value (numbers of predetermined test strips), an opening expired date and a number of test times. However, the control unit 13 is capable of conducting all signal processes in the biological sensing meter and controlling operations of all of the units inside the biological sensing meter. Furthermore, the control unit 13 configures a test configuration according to the tag information and calculates a test result from a responding signal. When the test configuration is in an abnormal state, the control unit 13 forbids (limits) the sensing unit 12 to process signals. A display unit 14 is capable of displaying the test results and displaying information of the test results through media such as audios, videos and symbols. The test results, the test configuration and hints indicative of success or failed messages could be designed inside or outside the biological sensing meter 10. Moreover, information such as time, a test number of present test item, interval of test results or hints about how to execute further processes could be provided for increasing user's understandings for relating information. The counting unit 15 is capable of counting the number of the test item through a predetermined value and adjusting the predetermined value after each test by the way of increasing or decreasing the predetermined value. When the number of the test item equals to the predetermined value, the counting unit 15 through the biological sensing meter 10 informs the user or further limits operations of the control unit. The counting unit 15 could be designed inside or outside the biological sensing meter 10. The wireless transmitting/receiving unit 16 is capable of receiving a tag information stored in a wireless data storage unit 20 and sending the tag information to the control unit 13. In the first embodiment, the wireless transmitting/receiving unit 16 is further capable of sending a specific information back to the wireless data storage unit 20. The tag information is stored in the wireless data storage unit 20 by applying RFID technique and the wireless data storage unit 20 could be configured on a container of the strip, such as a bottle top or a label, so as to access the wireless data storage unit 20 to the wireless transmitting/receiving unit 16. Thus, the tag information is sent to the biological sensing meter 10 for the configuration of the test configuration. The memory unit stores the information and records of the biological sensing meter 10.

The test configuration, which is configured through the tag information received by the wireless transmitting/receiving unit 16, is controlled by the control unit 13. The tag information at least comprises a test item, an expired date, a predetermined sensing value, an opening expired date and a number of test times or a combination selected from above parameters. The expired date is a first predetermined period or equals to the manufacturing date plus the first predetermined period or just a date indicating invalidation of the strip. The opening expired date means a date after the opening date pulsing a second predetermined period (such as 90 day or 3 months). The predetermined sensing value is a predetermined value having predetermined specs with different test times about each test item or the package of the strip.

Next, please referring to the FIG. 1B, a block diagram of a sensing biological meter of the second embodiment of the present invention is illustrated. In this embodiment, the feature different from the first embodiment of present invention is that the wireless transmitting/receiving unit 16 is replaced by a wireless data receiving unit 161. The wireless data receiving unit 161 is used for receiving the tag information without changing the data in the tag and sends the tag information to a control unit 13. Rest parts illustrated in FIG. 1B are similar with those with same symbols of FIG. 1A. For clarity, those are not redescribed hereafter.

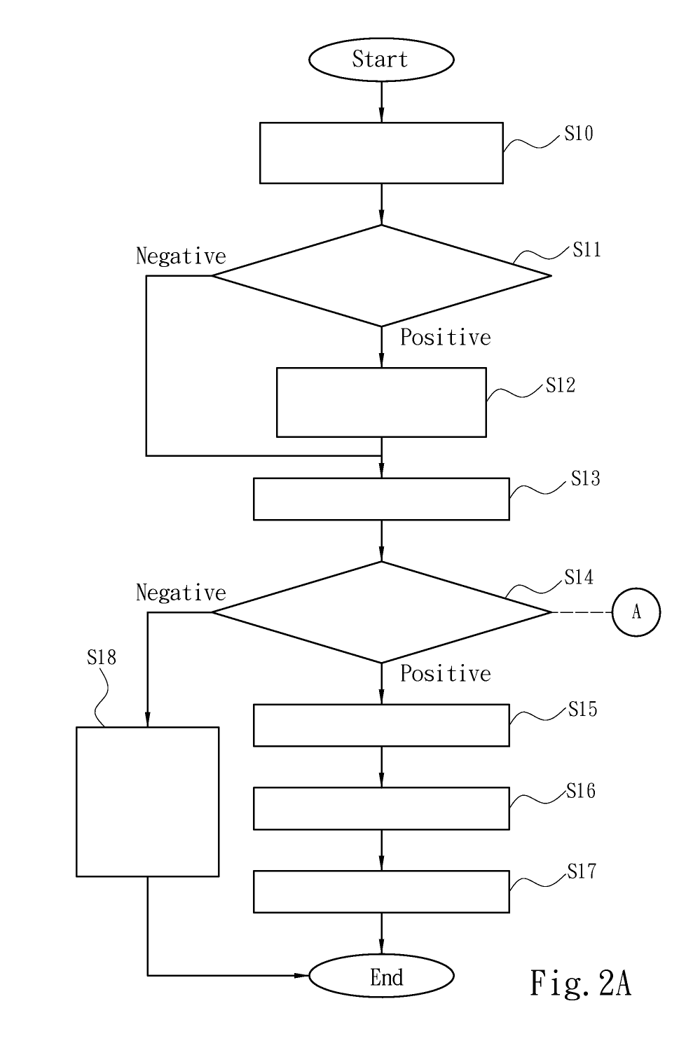

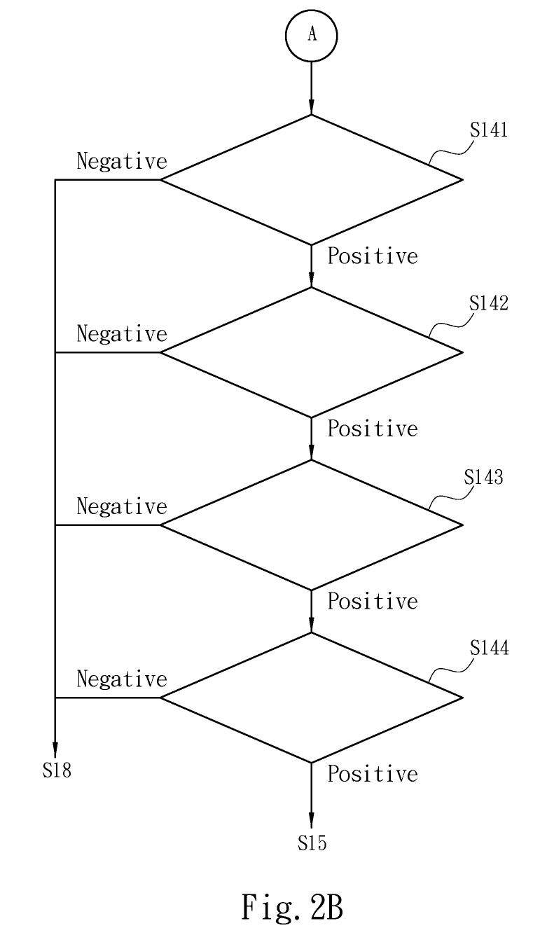

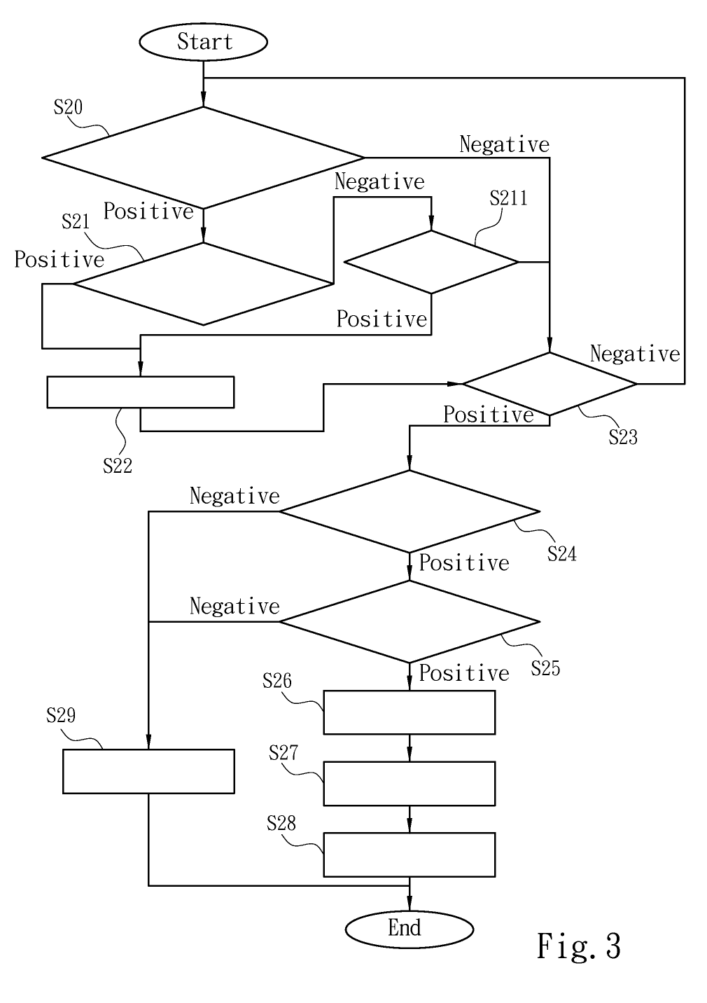

Please referring to the FIG. 2A and the FIG. 2B. The FIG. 2A and the FIG. 2B illustrate a flow chart of a data communicating method for the biological sensing unit of the present invention. The data communicating method comprises below step as illustrated in FIG. 2A: at first, in S10, a tag information is stored in a wireless data storage unit and the tag information is information stored by applying RFID technique, wherein the tag information at least comprises a test item, an expired date, a sensing predetermined value, an opening expired date and a number of test times. Next, in S11, the biological sensing meter 10 determines that if the tag information is received through the wireless transmitting/receiving unit 16. The wireless transmitting/receiving unit 16 reads RFID signals of the tag information via RFID technique. In S12, if the tag information is received in S11, the control unit configures a test configuration according to the tag information or the time the tag information is received. Because a RFID sensing process is operated only in the situation that strips of one lot is christened or strips are confirmed by a user, S13 would be conducted directly if the tag information is not received in S11. In S13, the user inserts a strip in a strip tank 11 for processing the test of the strip. Then, in S14, the control unit 13 determines if an operation of sensing function is conducted continuously according to the test configuration. In S14, a detail flow chart A is disclosed. Corresponding to FIG. 2A, the detail flow chart A comprises: determining if the strip matches a test item (S141), determining if the strip is not over the expired date (S142), determining if the strip is not over a opening expired date (S143) and determining if a test number of the test item is over a predetermined value (S144). In above flow chart, if one of results of S141, S142, S143 or S144 is negative (No), the test for the strip is limited. However, if all results of S141, S142, S143 or S144 are positive, the user is informed to re-access the tag information and executes S15. In S15, the strip is examined according to the configuration of the test configuration. Then in S17, a test result is outputted and recorded. In the end, the flow chart of the communicating method is terminated. Above test configuration at least comprises a test item, an expired date, a sensing predetermined value, an opening expired date and a number of test times. Detail steps for operating the test of the biological sensing meter is disclosed herein with reference FIGs. Please referring to FIG. 3, FIG. 3 illustrates an operating flow chart for applying the test of the strip of present invention. When the user uses the biological sensing meter 10 of the present invention to test, in S20, determining if a wireless transmitting/receiving unit 16 senses a tag information of a wireless data storage unit 20. If the tag information is not received by the wireless transmitting/receiving unit 16, it's directed to S23. If the tag information is received by the wireless transmitting/receiving unit 16, a control unit 13 determines if the strip is activated for the first time in S21. If in S21 it is not activated for the first time, then check if the tag information needs to be updated. If update is not needed, then it's directed to S23. If update is needed, similar to the first time determination in S21, the tag information is received to configure a test configuration in S22. Next, determining if the strip is inserted in the strip tank 11 of the biological sensing meter 10 in S23. In S24, a count unit 15 determines if a number of the test is smaller than a predetermined value. If the result of determination in S24 is negative, in S29, it's hinted that test is not available through an output unit 14 so as to the user about relating information or other possible operations. If the count unit 15 determines the number of the test is smaller than a predetermined value, in S25, the control unit 13 determines if the opening expired date of the tag information is still inside the available period. If the result of determination in S25 is negative, it's hinted by the output unit 14 to pursue in order to inform the user about relating information or other possible operations. If the opening expired date of the tag information is still inside the available period, the strip is tested through a sensing unit 12. Then, in S27, the test result is stored and presented through the output unit 14. In the end, the number of the test item by the counting unit 15 in S28 and the operating process of the biological sensing meter 10 of the present invention is completed.

In conclusion, the present invention relates to a biological sensing meter and data communicating method. Foregoing descriptions and drawings represent the preferred embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A biological sensing meter, sending tag information storied in a wireless data storage unit to the biological sensing meter through a wireless data transmission, comprising:
a wireless transmitting/receiving unit, for receiving the tag information, sending the tag information to a control unit and sending specific information back to the wireless data storage unit;
a control unit with functions of time-counting, operating all signal processes in the biological sensing meter and controlling all operations of units inside the biological sensing meter, wherein the control unit is capable of configuring a test configuration according to the tag information or a time point given by the tag information, calculating a test result from a response signal and further limiting a sensing unit signal process when the test configuration does not match a test condition;
a strip tank for inserting a test strip;
a sensing unit, limiting the sensing functions according to the test configuration provided by the control unit, testing the strip to generate the response signal and sending the response signal back to the control signal; and
a memory unit for storing all information and records of the biological sensing meter.

2. As cited in claim 1, further comprising an output unit, provided for displaying the test result, capable of showing information through audios, images or symbols.

3. As cited in claim 1, further comprising a count unit determining a number of the test through a predetermined sensing value.

4. As cited in claim 1, wherein the wireless data storage unit is selected from a group of an individual unit or a combination with a container of the strip.

5. As cited in claim 1, wherein the wireless data transmission is implemented by RFID technique.

6. As cited in claim 1, wherein the tag information is a strip test parameter comprising a test adjusts information and the test configuration.

7. As cited in claim 1, wherein information of the tag information comprising a test item, an expired date, a predetermined sensing value, an opening expired date, the sensing predetermined test and a combination selected from above parameters.

8. As cited in claim 1, wherein the test configuration at least comprising a strip test parameter and a opening expired date.

9. As cited in claim 1, wherein the test configuration comprising a test item, an expired date, a predetermined sensing value, an opening expired date and a number of test times or a combination selected from above parameters.

10. a biological sensing meter, sending tag information storied in a wireless data storage unit to the biological sensing meter through a wireless data transmission, comprising:
a wireless receiving unit, for receiving the tag information, sending the tag information to a control unit;
a control unit, operating all signal processes in the biological sensing meter and controlling all operations of units inside the biological sensing meter, wherein the control unit is capable of configuring a test configuration according to the tag information, calculating a test result from a response signal and further limiting a sensing unit signal process when the test configuration is in an abnormal condition;
a strip tank for inserting a test strip;
a sensing unit, limiting the sensing functions according to the test configuration provided by the control unit, testing the strip to generate the response signal and sending the response signal back to the control signal; and
a memory unit for storing all information and records of the biological sensing meter.

11. As cited in claim 10, further comprising an output unit, provided for displaying the test result, capable of showing information through audios, images or symbols.

12. As cited in claim 10, further comprising a count unit determining a number of the test through a predetermined sensing value.

13. As cited in claim 10, wherein the wireless data storage unit is selected from a group of an individual unit or a combination with a container of the strip.

14. As cited in claim 10, wherein the wireless data transmission is implemented by RFID technique.

15. As cited in claim 10, wherein the tag information is a strip test parameter comprising a test adjusts information and the test configuration.

16. As cited in claim 10, wherein information of the tag information comprising a test item, an expired date, a predetermined sensing value, an opening expired date, the sensing predetermined test and a combination selected from above parameters.

17. As cited in claim 10, wherein the test configuration at least comprising a strip test parameter and a opening expired date.

18. As cited in claim 10, wherein the test configuration comprising a test item, an expired date, a predetermined sensing value, an opening expired date and a number of test times or a combination selected from above parameters.

19. a communicating method for a biological sensing meter, comprising:
storing a tag information in a wireless data storage unit;
If the tag information is received through a wireless transmitting/receiving unit;
configuring a test configuration through a control unit;
inserting a strip in a strip tank;
determining if sensing functions could be executed continuously according to the test configuration by the control unit;
adjusting the test configuration; and
outputting a test result according to a response signal of the strip.

20. As cited in claim 19, wherein the wireless data transmission is implemented by RFID technique.

21. As cited in claim 19, wherein the tag information is a strip test parameter comprising a test adjusts information and the test configuration.

22. As cited in claim 19, wherein the tag information comprising a test item, an expired date, the strip test parameter, a predetermined sensing parameter and a combination selected from above parameters.

23. As cited in claim 19, wherein the test configuration at least comprising the strip test parameter and an opening expired date.

24. As cited in claim 19, wherein the test configuration comprising a test item, an expired date, a predetermined sensing value, the strip test parameter, an opening expired date, the sensing predetermined test and a number of the test.

25. As cited in claim 19, wherein the control unit calculating a time point of the tag information read from the wireless data storage unit by the control unit, determining if the step of sensing functions could be executed according to the test configuration and displaying corresponding hints.

26. As cited in claim 25, wherein the control unit further comprising a step for determining if the strip fits the test item.

27. As cited in claim 25, wherein the control unit further comprising a step for determining if the strip fits the expired date.

28. As cited in claim 25, wherein the control unit further comprising a step for determining if the strip fits the opening expired date.

29. As cited in claim 25, wherein the control unit further comprising a step for determining if the number of the test item is over the sensing predetermined value.
